(19) United States
(12) Patent Application Publication
(10) Pub. No.: US 2022/0049937 A1
(43) Pub. Date: Feb. 17, 2022

(54) METHODS, SYSTEMS, APPARATUSES, AND DEVICES FOR FACILITATING CLEANING OF A PROJECTILE LAUNCHING SYSTEM

(71) Applicant: Seth Alan Lowell, Macungie, PA (US)

(72) Inventor: Seth Alan Lowell, Macungie, PA (US)

(21) Appl. No.: 16/991,976

(22) Filed: Aug. 12, 2020

(51) Int. Cl. F42B 5/24; F42B 14/04; F42B 7/08; B08B 9/032

(52) U.S. Cl. CPC F42B 5/24; B08B 9/0325; F42B 7/08; F42B 14/04

(57) ABSTRACT

Disclosed herein is a cleaning ammunition for facilitating cleaning of a projectile launching system, in accordance with some embodiments. Accordingly, the cleaning ammunition may include a casing and a cleaning projectile. Further, the casing traversable through a barrel of the projectile launching system. Further, the casing may include a proximal end and a distal end. Further, the casing may include a propellant disposed within an interior space of the casing at the proximal end. Further, the casing may include a primer disposed alongside the propellant. Further, the primer is configured to ignite the propellant based on a striking force receivable from a launching mechanism of the projectile launching system. Further, the cleaning projectile disposed within the interior space adjacent to the propellant. Further, the cleaning projectile is disposed at the distal end of the casing. Further, the cleaning projectile may be configured for performing a cleaning action on the barrel.

### FIELD OF THE INVENTION

Generally, the present disclosure relates to the field of ammunition and explosives. More specifically, the present disclosure relates to methods, systems, apparatuses, and devices for facilitating cleaning of a projectile launching system.

### BACKGROUND OF THE INVENTION

In the past cleaning of the weapon system may require bringing the weapon system from the firing line or the field environment. Further, the cleaning may also require disassembling the weapon system. Further, the cleaning may require dumping a cleaning solution dumped down a barrel of the weapon system after disassembling the weapon system. Further, the cleaning may require removing and breaking up the carbon using a rod or barrel rope/snake with a metal attachment on it. Further, the barrel rod or snake may include a cleaning patch placed on the end of it to be pushed or pulled down the barrel to remove the carbon. Further, the cleaning may require running the barrel rod or snake with a clean cleaning patch with oil on to protect the chrome inner lining of the barrel from rust and building up of more carbon.

Therefore, there is a need for improved methods, systems, apparatuses, and devices for facilitating cleaning of a projectile launching system that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a cleaning ammunition for facilitating cleaning of a projectile launching system, in accordance with some embodiments. Accordingly, the cleaning ammunition may include a casing and at least one cleaning projectile. Further, the casing traversable through a barrel of the projectile launching system. Further, the casing may include a proximal end and a distal end. Further, the casing may include at least one propellant disposed within an interior space of the casing at the proximal end. Further, the casing may include a primer disposed alongside the at least one propellant. Further, the primer may be configured to ignite the at least one propellant based on a striking force receivable from a launching mechanism of the projectile launching system. Further, the at least one cleaning projectile disposed within the interior space adjacent to the at least one propellant. Further, the at least one cleaning projectile may be disposed at the distal end of the casing. Further, the at least one cleaning projectile may be configured for performing at least one cleaning action on the barrel.

Further disclosed herein is a kit for facilitating cleaning a projectile launching system, in accordance with some embodiments. Accordingly, the kit may include at least one cleaning ammunition, and the projectile launching system. Further, he at least one cleaning ammunition may include a casing and at least one cleaning projectile. Further, the casing may be traversable through a barrel of the projectile launching system. Further, the casing may include a proximal end and a distal end. Further, the casing may include at least one propellant disposed within an interior space of the casing at the proximal end. Further, the casing may include a primer disposed alongside the at least one propellant. Further, the at least one cleaning projectile may be disposed within the interior space adjacent to the at least one propellant. Further, the at least one cleaning projectile may be disposed at the distal end of the casing. Further, the at least one cleaning projectile may be configured for performing at least one cleaning action on the barrel. Further, the projectile launching system may be configured for launching at least one cleaning ammunition through the barrel. Further, a launching mechanism of the projectile launching system may be configured for transferring a striking force to the primer. Further, the primer may be configured to ignite the at least one propellant based on the transferring of the striking force.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a front view a cleaning ammunition for facilitating cleaning of a projectile launching system, in accordance with some embodiments.

FIG. 2 is a perspective view of the cleaning ammunition, in accordance with some embodiments.

FIG. 3 is a front view of the cleaning ammunition, in accordance with some embodiments.

FIG. 4 is a perspective view of the cleaning ammunition, in accordance with some embodiments.

FIG. 5 is a front view of a cleaning ammunition, in accordance with some embodiments.

FIG. 6 is a perspective view of the cleaning ammunition, in accordance with some embodiments.

FIG. 7 is a front view of the cleaning ammunition, in accordance with some embodiments.

FIG. 8 is a perspective view of the cleaning ammunition, in accordance with some embodiments.

FIG. 9 is a front perspective view of the launching assembly, in accordance with some embodiments.

FIG. 10 is a rear perspective view of the launching assembly, in accordance with some embodiments.

FIG. 11 is a partial cross-sectional view of the launching assembly, in accordance with some embodiments.

FIG. 12 is a perspective view of the launching assembly with the projectile launching system, in accordance with some embodiments.

FIG. 13 is a side view of the launching assembly with the projectile launching system, in accordance with some embodiments.

FIG. 14 is a cross-sectional view of the projectile launching system taken along a line A-B of the FIG. 13, in accordance with some embodiments

FIG. 15 is a schematic view of a kit for facilitating cleaning a projectile launching system, in accordance with some embodiments.

FIG. 16 is a front view of the at least one cleaning ammunition, in accordance with some embodiments.

FIG. 17 is a perspective view of the launching assembly with the projectile launching system, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses and devices for facilitating cleaning of a projectile launching system, embodiments of the present disclosure are not limited to use only in this context.

Overview:

The present disclosure describes systems, methods, apparatuses, and devices for facilitating cleaning of a projectile launching system. Further, the present disclosure describes a cleaning ammunition for facilitating the cleaning of the projectile launching system (weapon system). Further, the cleaning ammunition uses a combination of already tested and proven cleaning products in a new manner to allow for rapid cleaning and protection for a weapon system without disassembling the weapon system in the field or at the range. Further, the weapon system may become very dirty and after firing approximately 100 rounds. To keep the weapon system as accurate as possible and running in perfect condition the removal of carbon is required. Carbon is released by normal ammunition into the barrel and gas system of the weapon system. Further, the carbon causes fouling and the dirtying of the weapon system.

By adding the AAR rounds (cleaning ammunition) after every 100 rounds, the weapon system can be cleaned. The weapon system may be brought back to an acceptable level of cleanliness by firing the AAR rounds to ensure proper functionality of the weapon system to allow for the best possible accuracy. The AAR rounds use cleaning solution/oil/cleaning wads/patches that are fired under pressure in a specific step by step process to allow for a rapid way to clean the weapon system without disassembly.

Further, the AAR rounds are for all calibers of small arms, heavy weapon calibers, mortars, rockets, artillery, cannons, naval cannons, machine guns, machine cannons, rifles, handguns, electro-magnetic launchers, and any other projectile launching weapon system. Further, the AAR rounds may be used to clean all calibers of the small arms, the heavy weapon calibers, the mortars, the rockets, the artillery, the cannons, the naval cannons, the machine guns, the machine cannons, the rifles, the handguns, the electro-magnetic launchers, and any other projectile launching weapon system.

Further, the present disclosure describes the cleaning round (cleaning ammunition) is a light load gun powder charge that sits behind a dissolvable case that holds a cleaning solution. When the cleaning round is chambered into the pistol or rifle (weapon system) and fired the dissolvable case is ruptured and the cleaning solution is sent down the barrel of the weapon system, into the gas system, and silencer. The pressure along with the cleaning solution breaks down and removes carbon or debris from the barrel without having to use a cleaning rod or snake in the barrel. A small pop occurs with just enough gun powder to fire the cleaning fluid through the weapon system with enough force to remove all carbon. Further, 3 cleaning solution rounds are fired first to remove carbon. Further, 3 Oil and cleaning solution rounds are fired next to further clean and lubricate the weapon system.

Further, 2 oil and cleaning patches are fired next. Further, 2 dry cleaning patches are fired last.

Further, the present disclosure describes an after-action round (the cleaning ammunition). Further, the after-action round (AAR) comes in a 10-step process. The 1st round has the most gunpowder and most cleaning solution. The 2nd round has the most gunpowder and most cleaning solution. The 3rd round has the most gunpowder and most cleaning solution. The 4th round has just an oil and cleaning solution. The 5th round has an oil and cleaning solution. The 6th round has the oil and the cleaning solution. The 7th round has cleaning wad and the oil. The 8th round has the cleaning wad and the oil. The 9th round is a dry cleaning wad. The 10th round is the dry cleaning wad. For silencers attached, the cleaning wad is not be used.

Further, the AAR round may include a casing. Further, the casing may be caliber specific. Further, a detonation primer is placed in the back of the casing that when struck by the firing pin of the weapon system it ignites the gunpowder placed in front of the primer at the very bottom of the caliber specific casing. The neck of the casing that is there to hold the bullet is straightened out and the end of the casing is crimped as to ensure the rupturing of the capsule that is holding the cleaning solution and oil that sits directly in front of the gunpowder. Further, the AAR round may include a capsule. Further, the capsule is made of a material that ruptures under the pressure of the gunpowder igniting. Further, the capsule holds the cleaning solution and oil. Further, the capsule is designed to disintegrate and liquefy upon the application of heat from the gunpowder detonating behind the capsule. The capsule is made of a cleaning solution in a jellified state. Further, the AAR round may include a cleaning wad. Further, the cleaning wad is made of cotton or other synthetic material commonly used in cleaning the weapon system. Further, the cleaning wad is shaped to fit snugly in front of the capsule. Further, the cleaning wad is pressed into the casing and is the final step of completion of the AAR round. Each AAR 10 pack or other designated amount of AAR rounds is made to fit all calibers of all weapon systems. This allows the shooter to service the weapon system in harsh environments or in a rush if immediate care to the weapon system is needed. The AAR round is not intended to replace traditional cleaning steps but to provide an immediate step currently unavailable to users in the shooting world. This field-expedient cleaning process would greatly benefit hunters that may have fallen or got debris in their barrel, soldiers in combat that may need to clean their weapon system in unsafe environments where disassembling the weapon system may not be warranted or shooters at the range for extended periods of time. Further, the cleaning process may make use of a solvent trap. If the weapon system has a threaded barrel, then the solvent trap can be attached to allow for the capture of the cleaning wad and cleaning solution to ensure a clean and safe environment. Cleaning wads are not recommended to be fired through silencers. Multiple small holes drilled in the end cap of the solvent trap will allow for the pressure to escape but not the cleaning wad and very little cleaning solution or oil.

Further, the present disclosure describes the launching of the AAR round using alternate propellants. Further, the alternate propellant may use Co2 & Nitrogen. The Cleaning round is comprised of cleaning solution capsule or oil and cleaning wad but has the primer & gun powder removed and a screw-in port to allow a Co2 tubular pressure line that connects to a handheld Co2 cartridge holding chamber. As the Co2 cartridge is pressed into the handheld chamber the Co2 cartridge is ruptured and releases the pressure into a regulation chamber. This pressure is then released by pressing a button on the side of the handheld chamber that sends the pressure through the tube leading into the AAR round. That pressure then ruptures the cleaning solution capsule and or oil capsule with cleaning wad and the barrel of the weapon system is cleaned. The bolt of the weapon system is left open and the AAR round is placed in the chamber of the weapon system and pushed into the chamber by hand. The bolt of the weapon system is then closed onto the seated AAR round in the chamber. Then the AAR round is removed by locking the bolt back in the open position and then the user simply pulls the Co2 or Nitrogen tube back or by unscrewing the tube port into the AAR round releasing the bolt of the weapon system to grab the base of the round and then pulling the bolt back to extract the round from the chamber like traditional ammunition. Further, Co2 or nitrogen cartridges can be used interchangeably. This allows for a safe design that will ensure the cleaning rounds are never mixed up with real projectile ammunition. Further, no gun powder or primer reduces shipping & insurance costs. Further, it is biologically safe since the cleaning solution can be trapped better. Further, it reduces distance and or force of cleaning wad/cleaning solution/oil.

Further, a system for facilitating cleaning of the weapon system may not be a total replacement for traditional ways of cleaning the weapon system but the system may provide a quick and easy solution for maintenance of the weapon system in between proper cleanings. Further, the system may be beneficial for keeping the weapon clean to continue proper function for long days at the range. Further, the system may be beneficial for soldiers when proper gun care cannot be attained yet quick maintenance is required. Since, small amounts of carbon which is beneficial to the operation of the weapon system, the system uses cleaning solutions and oils that are pushed through the weapon system under pressure to safely remove high levels of carbon fouling collected in the weapon system after hundreds of rounds fired. Further, the system may use an internal power washing system of cleaning solutions and oils to clean barrels. Further, the system may provide a way to clean silencers that cannot be taken apart for cleaning purposes. Further, the system may be beneficial for hunters on extended trips. Further, the present system may be beneficial for shooters that may have fallen or got dirt and mud in their barrel that needs a quick way to expel and clean the weapon system in the field with zero tools.

Further, the AAR round may include a brass case ammunition, a polymer case ammunition, a steel case ammunition, an aluminum case ammunition, a tin Case ammunition. Further, the AAR round may include any other metal or polymer or plastic materials in any combination that can be used to shape a weapon caliber projectile case that is chambered into a weapon's bore. Further, the AAR round may include gun/weapon cleaning solution. Further, the gun/weapon cleaning solution may be flammable. Further, the gun/weapon cleaning solution may be nonflammable. Further, the gun/weapon cleaning solution may be biologically safe. Further, the AAR round may include gun/weapon oil/lubricant. Further, the AAR round may include gun/weapon cleaning patches/wads/or objects. Further, the gun/weapon cleaning patches/wads/or objects may be used for cleaning barrels of the weapon system. Further, the gun/weapon cleaning patches/wads/or objects are comprised of cotton or other blended fabric mixes. Further, the AAR round may include gun powder & binary chemical or explosive charges. Further, the AAR round may include Co2 pressure case & other gasses like nitrogen or O2 used for projection of items/solutions. Further, a spring-loaded system and a pneumatic pressure system may be used to launch the items/solutions.

Further, the present disclosure describes a weapons cleaning kit. Further, the weapon cleaning kit may use a charge placed in a caliber specific casing that holds a cleaning solution, oil and cleaning wad that is fired down the barrel of the weapon system for facilitating cleaning and lubricating the weapon system to preform intermittent cleaning and lubricating maintenance of the weapon system at the range or in the field.

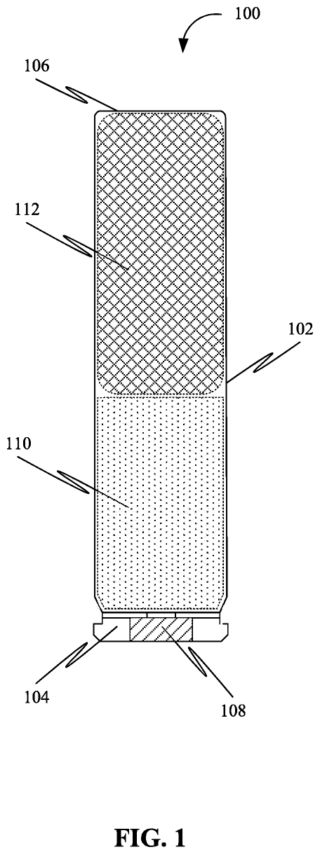

FIG. 1 is a front view a cleaning ammunition 100 for facilitating cleaning of a projectile launching system 1202, in accordance with some embodiments. Further, the cleaning ammunition 100 may include a casing 102 and at least one cleaning projectile 112. Further, the projectile launching system 1202 may include at least one weapon system. Further, the at least one weapon system may include an artillery, a firearm, etc. Further, the firearms may include a manual firearm, a semiautomatic firearm, an automatic firearm, etc. Further, the manual firearm may include an air gun, a blowgun, a carbine, a handgun, a rifle, a shotgun, etc. Further, the semiautomatic firearm may include a handgun, a rifle, etc. Further, the automatic firearm may include a handgun, a machine gun, a rifle, a submachine gun, etc. Further, the casing 102 may include at least one casing material. Further, the at least one casing material may include at least one metal, at least one polymer, etc. Further, the at least one metal may include brass, steel, aluminum, tin, etc. Further, the casing 102 may include at least one combination of at least two casing materials. Further, the at least one cleaning projectile 112 may include at least one cleaning material. Further, the at least one cleaning material may include at least one cleaning solution, at least one lubricant, at least one cleaning wad, etc. Further, the at least one cleaning solution may be a flammable solution, a non-flammable solution, a biologically safe solution, etc. Further, the at least one lubricant may include at least one oil. Further, the at least one cleaning wad may include at least one fabric. Further, the at least one fabric may include a natural fabric, a synthetic fabric, etc. Further, the at least one cleaning wad may include at least one blend of the natural fabric and the synthetic fabric.

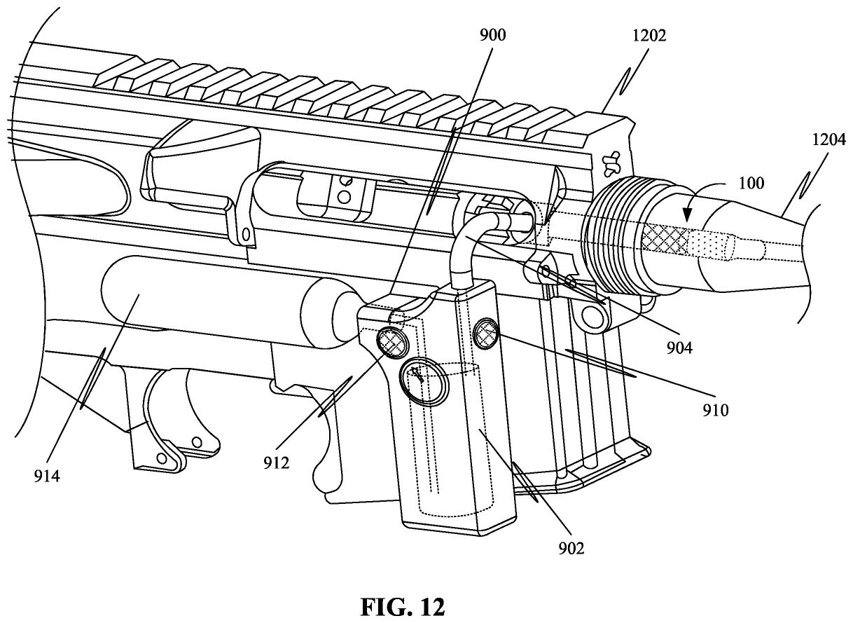

Further, the casing 102 may be traversable through a barrel 1204, as shown in FIG. 12, of the projectile launching system 1202, as shown in FIG. 12. Further, the casing 102 may include a proximal end 104 and a distal end 106. Further, the distal end 106 may be crimped. Further, the casing 102 may include at least one propellant 110 disposed within an interior space of the casing 102 at the proximal end 104. Further, the at least one propellant 110 may include at least one explosive material. Further, the at least one explosive material may include a binary explosive, a plastic explosive, etc. Further, the plastic explosive may include C-3, C-4, Semtex, etc. Further, the at least one propellant 110 may include gunpowder (black powder), nitrocellulose-based powder, cordite, ballistite, smokeless powder, an explosive charge, etc. Further, the casing 102 may include a primer 108 disposed alongside the at least one propellant 110. Further, the primer 108 may be configured to ignite the at least one propellant 110 based on a striking force receivable from a launching mechanism of the projectile launching system 1202. Further, the launching mechanism may include a firing mechanism of the weapon system. Further, the casing 102 may include a size designation. Further, the size designation may include AAR-0.223/5.53.

Further, the at least one cleaning projectile 112 may be disposed within the interior space adjacent to the at least one propellant 110. Further, the at least one cleaning projectile 112 may be disposed at the distal end 106 of the casing 102. Further, the at least one cleaning projectile 112 may be configured for performing at least one cleaning action on the barrel 1204. Further, the at least one cleaning action may include scrubbing, scraping, lubricating, wiping, etc.

Further, in some embodiments, the at least one cleaning projectile 112 may include a first cleaning projectile, a second cleaning projectile, a third cleaning projectile, and a fourth cleaning projectile. Further, the first cleaning projectile may include at least one cleaning agent. Further, the at least one cleaning agent may include the at least one cleaning solution. Further, the second cleaning projectile may include the at least one cleaning agent and at least one lubricating agent. Further, the at least one lubricating agent may include the at least one oil. Further, the third cleaning projectile may include the at least one lubricating agent and the at least one cleaning wad. Further, the fourth cleaning projectile may include the at least one cleaning wad.

Further, in some embodiments, the cleaning ammunition 100 may include a plurality of cleaning ammunitions. Further, the projectile launching system 1202 may be configurable for launching the plurality of cleaning ammunitions through the barrel 1204 for facilitating the cleaning of the barrel 1204. Further, each cleaning ammunition of the plurality of cleaning ammunitions may be associated with an index of a plurality of indices. Further, the plurality of cleaning ammunitions may include a first cleaning ammunition, a second cleaning ammunition, a third cleaning ammunition, a fourth cleaning ammunition, a fifth cleaning ammunition, a sixth cleaning ammunition, a seventh cleaning ammunition associated, an eighth cleaning ammunition, a ninth cleaning ammunition, and a tenth cleaning ammunition. Further, the plurality of cleaning ammunitions may be launched in an ascending order of the index. Further, the first cleaning ammunition, the second cleaning ammunition, and the third cleaning ammunition may include the first cleaning projectile. Further, the fourth cleaning ammunition, the fifth cleaning ammunition, and the sixth cleaning ammunition may include the second cleaning projectile. Further, the seventh cleaning ammunition and the eighth cleaning ammunition may include the third cleaning projectile. Further, the ninth cleaning ammunition and the tenth cleaning ammunition may include the fourth cleaning projectile. Further, the projectile launching system 1202 may be configurable for launching the first cleaning ammunition. Further, the projectile launching system 1202 may be configurable for launching the second cleaning ammunition after the launching of the first cleaning ammunition. Further, the projectile launching system 1202 may be configurable for launching the third cleaning ammunition after the launching of the second cleaning ammunition. Further, the projectile launching system 1202 may be configurable for launching the fourth cleaning ammunition after the launching of the third cleaning ammunition. Further, the projectile launching system 1202 may be configurable for launching the fifth cleaning ammunition after the launching of the fourth cleaning ammunition. Further, the projectile launching system 1202 may be configurable for launching the sixth cleaning ammunition after the launching of the fifth cleaning ammunition. Further, the projectile launching system 1202 may be configurable for launching the seventh cleaning ammunition after the launching of the sixth cleaning ammunition. Further, the projectile launching system 1202 may be configurable for launching the eighth cleaning ammunition after the launching of the seventh cleaning ammunition. Further, the projectile launching system 1202 may be configurable for launching the ninth cleaning ammunition after the launching of the eighth cleaning ammunition. Further, the projectile launching system 1202 may be configurable for launching the tenth cleaning ammunition after the launching of the ninth cleaning ammunition.

Further, in some embodiments, the at least one cleaning projectile 112 may include at least one projectile and at least one of at least one cleaning agent, at least one lubricating agent, and at least one cleaning wad disposed on an outer surface of the at least one projectile. Further, in an embodiment, the at least one projectile may include at least one projectile material. Further, the at least one projectile material may include metal, plastic, rubber, sponge, etc. Further, the at least one projectile may be propelled through the barrel 1204 with at least one projectile velocity based on the ignition of the at least one propellant 110. Further, the at least one projectile may be destructive for at least one object based on the at least one projectile material and the at least one projectile velocity. Further, the at least one object may include a human, an animal, etc. Further, in an embodiment, the at least one projectile may be traversable through the barrel 1204. Further, the at least one projectile may be propelled through the barrel 1204 based on the ignition of the at least one propellant 110. Further, the at least one projectile does not perform the at least one cleaning action. Further, the at least one projectile may be configured for carrying the at least one of the at least one cleaning agent, the at least one lubricating agent, and the at least one cleaning wad through the barrel 1204 for performing the at least one cleaning action.

Further, in some embodiments, the barrel 1204 may include at least one material disposed in the barrel 1204. Further, the at least one material may include a carbon material. Further, the carbon material may be deposited on an inner surface of the barrel 1204. Further, the at least one cleaning projectile 112 may be configured for fragmenting the carbon material. Further, the at least one cleaning projectile 112 may be configured for expelling the carbon material through an opening of the barrel 1204. Further, the at least one cleaning projectile 112 may be configured for removing the carbon material from the barrel 1204 based on the expelling.

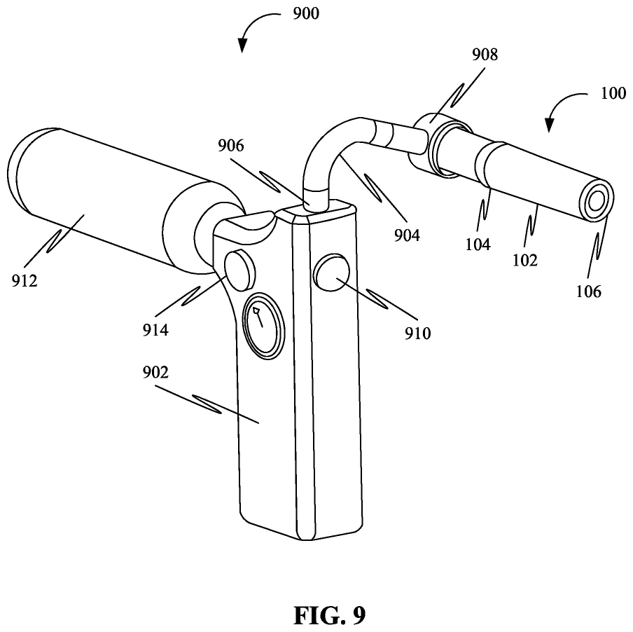

In further embodiments, a launching assembly 900, as shown in FIG. 9, coupled with the projectile launching system 1202. Further, the launching assembly 900 may be configured for launching the cleaning ammunition 100 through the barrel 1204 of the projectile launching system 1202. Further, the launching assembly 900 may include at least one chamber 902, a switch 910, and at least one tube 904. Further, the at least one chamber 902 may be a regulator/accumulator. Further, the switch 910 may be a clean button. Further, the launching assembly 900 may include an accumulator pressure gauge. Further, a first end 906 of the at least one tube 904 may be coupled with the at least one chamber 902. Further, a second end 908 of the at least one tube 904 may be disposable in the barrel 1204 adjacent to the proximal end 104 of the casing 102. Further, the second end 908 may include an external cartridge adapter. Further, the external cartridge adapter may facilitate coupling of the second end 908 with the proximal end 104. Further, the switch 910 may be coupled with the at least one chamber 902. Further, the at least one chamber 902 may include at least one first propellant. Further, the at least one first propellant may include at least one pressurized gas. Further, the at least one pressurized gas may include pressurized nitrogen gas, pressurized oxygen gas, pressurized carbon dioxide gas, etc. Further, the switch 910 may be configured for receiving a switching action. Further, the switching action may include a push action on the switch 910. Further, the switch 910 may be configured for releasing the at least one first propellant from the at least one chamber 902 to the barrel 1204 through the at least one tube 904 based on the receiving of the switching action. Further, the at least one cleaning projectile 112 may be launched through the barrel 1204 based on the releasing. Further, in an embodiment, the launching assembly 900 may include at least one first chamber 912 and at least one first switch 914. Further, the at least one first chamber 912 may be an external charge cartridge. Further, the at least one first switch 914 may be an accumulator fill button. Further, the at least one first chamber 912 may be coupled with the at least one chamber 902. Further, the at least one first switch 914 may be coupled with the at least one first chamber 912. Further, the at least one first chamber 912 may include at least one cartridge of the at least one first propellant. Further, the at least one first switch 914 may be configured for receiving a switching action. Further, the switching action may include a push action on the at least one switch 914. Further, the at least one cartridge may be configured for rapturing based on the receiving of the switching action. Further, the at least one cartridge releases the at least one first propellant into the at least one chamber 902 based on the rapturing.

Further, in some embodiments, the at least one cleaning projectile 112 may include at least one cleaning material. Further, the at least one cleaning material may include the at least one cleaning solution, at least one cleaning substance, etc. Further, a gas system of the projectile launching system 1202 may be coupled with the barrel 1204. Further, the at least one cleaning projectile 112 may be configured for dispensing the at least one cleaning material in the barrel 1204 and the gas system. Further, the at least one cleaning material may be configured for performing the at least one cleaning action on the barrel 1204 and the gas system.

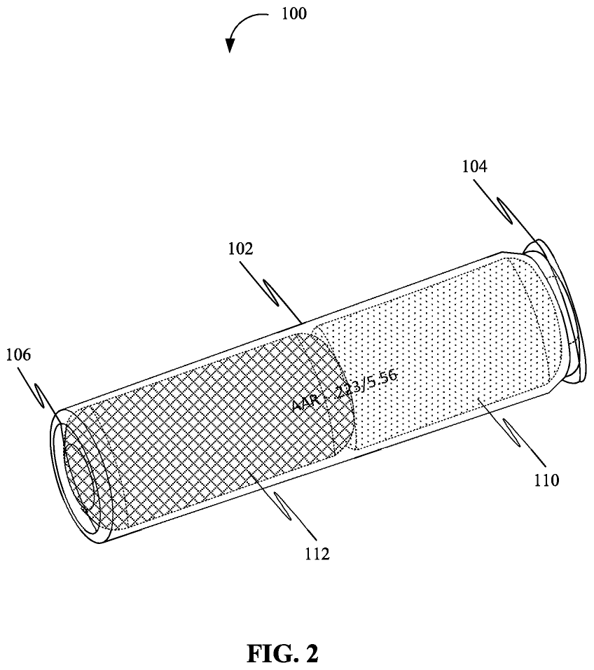

FIG. 2 is a perspective view of the cleaning ammunition 100, in accordance with some embodiments.

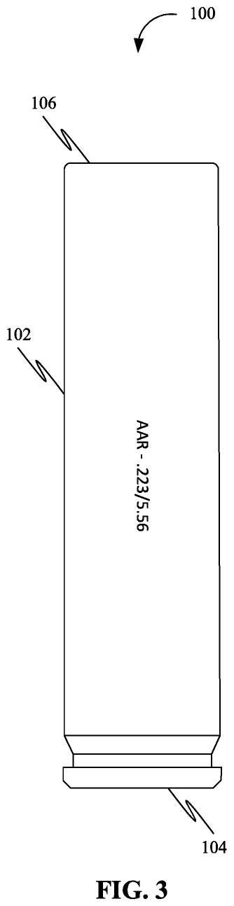

FIG. 3 is a front view of the cleaning ammunition 100, in accordance with some embodiments.

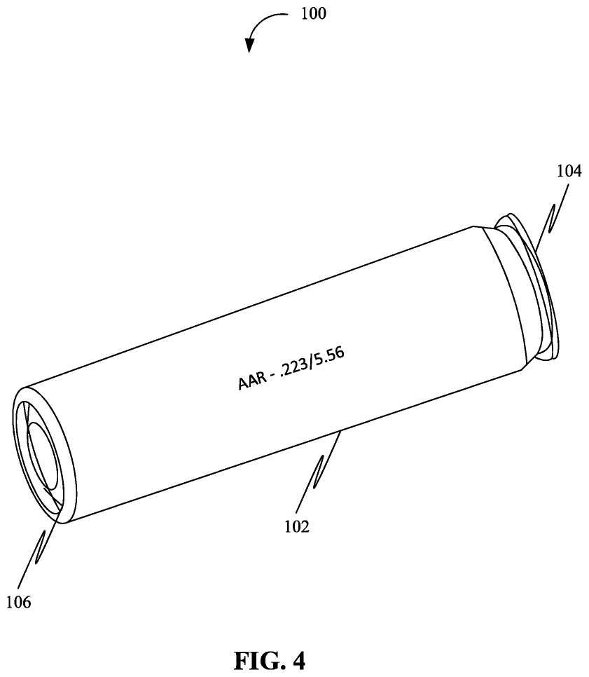

FIG. 4 is a perspective view of the cleaning ammunition 100, in accordance with some embodiments.

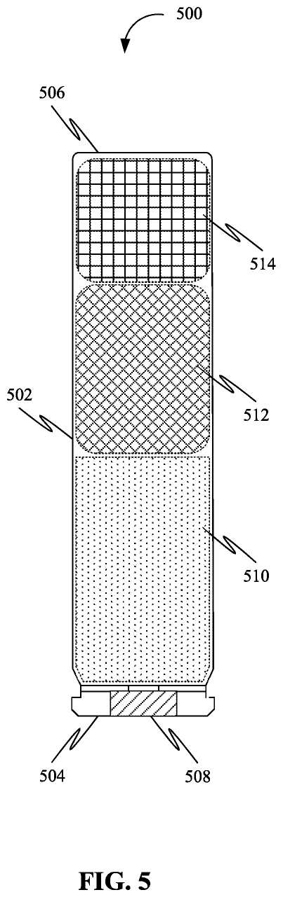

FIG. 5 is a front view of a cleaning ammunition 500, in accordance with some embodiments. Further, the cleaning ammunition 500 may include a casing 502 and at least one cleaning projectile.

Further, the casing 502 may be traversable through a barrel of the projectile launching system. Further, the casing 502 may include a proximal end 504 and a distal end 506. Further, the casing 502 may include at least one propellant 510 disposed within an interior space of the casing 502 at the proximal end 504. Further, the casing 502 may include a primer 508 disposed alongside the at least one propellant 510. Further, the primer 508 may be configured to ignite the at least one propellant 510 based on a striking force receivable from a launching mechanism of the projectile launching system.

Further, the at least one cleaning projectile may be disposed within the interior space adjacent to the at least one propellant 510. Further, the at least one cleaning projectile may include a first cleaning projectile 512 and a second cleaning projectile 514. Further, the at least one cleaning projectile may be disposed at the distal end 506 of the casing 502. Further, the at least one cleaning projectile may be configured for performing at least one cleaning action on the barrel.

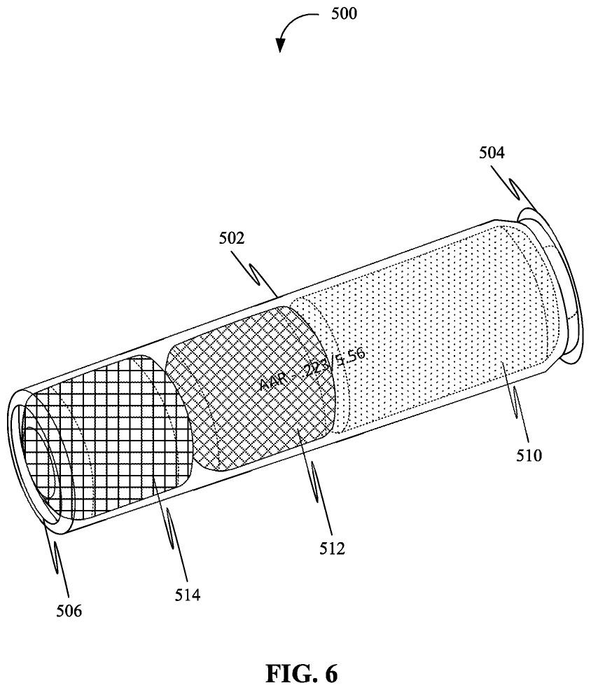

FIG. 6 is a perspective view of the cleaning ammunition 500, in accordance with some embodiments.

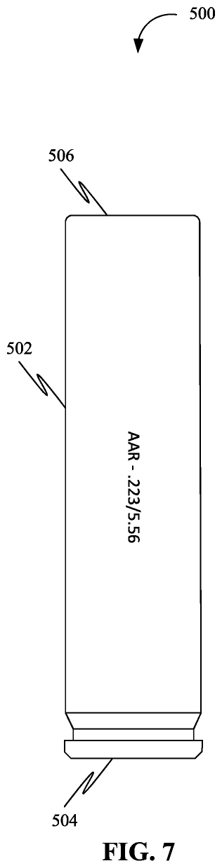

FIG. 7 is a front view of the cleaning ammunition 500, in accordance with some embodiments.

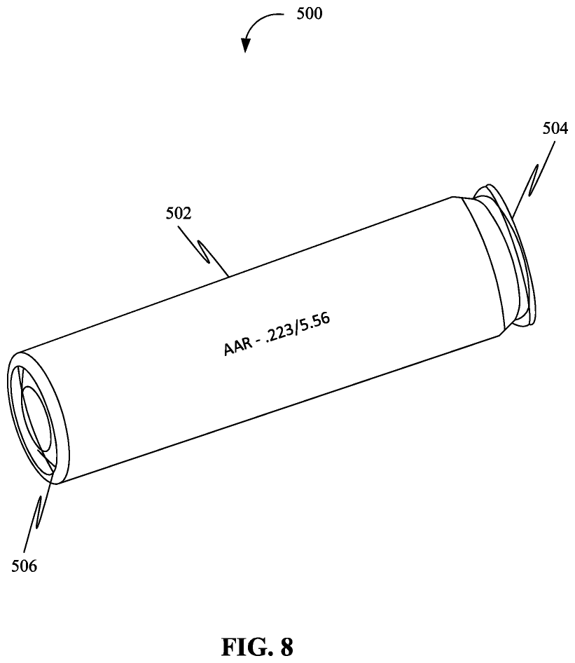

FIG. 8 is a perspective view of the cleaning ammunition 500, in accordance with some embodiments.

FIG. 9 is a front perspective view of the launching assembly 900, in accordance with some embodiments.

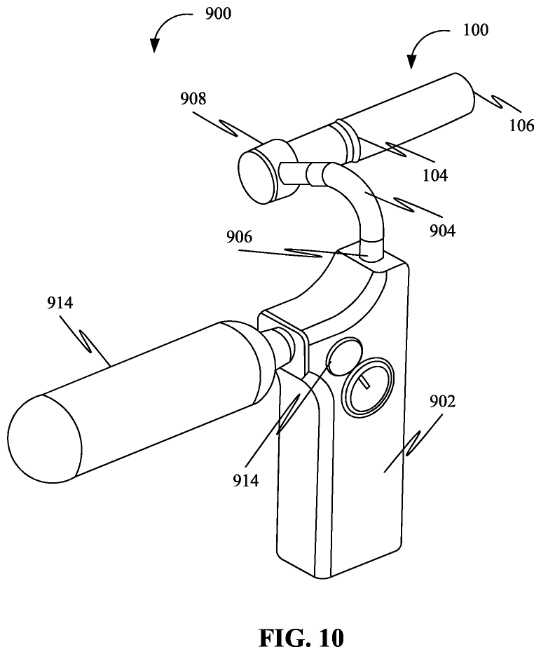

FIG. 10 is a rear perspective view of the launching assembly 900, in accordance with some embodiments.

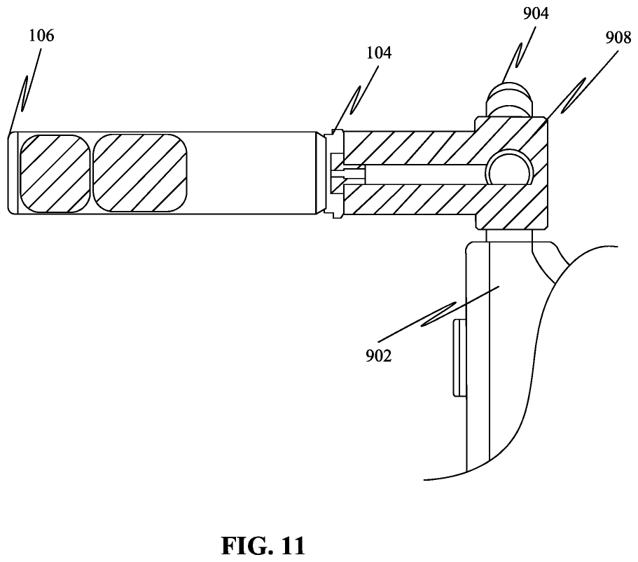

FIG. 11 is a partial cross-sectional view of the launching assembly 900, in accordance with some embodiments.

FIG. 12 is a perspective view of the launching assembly 900 with the projectile launching system 1202, in accordance with some embodiments.

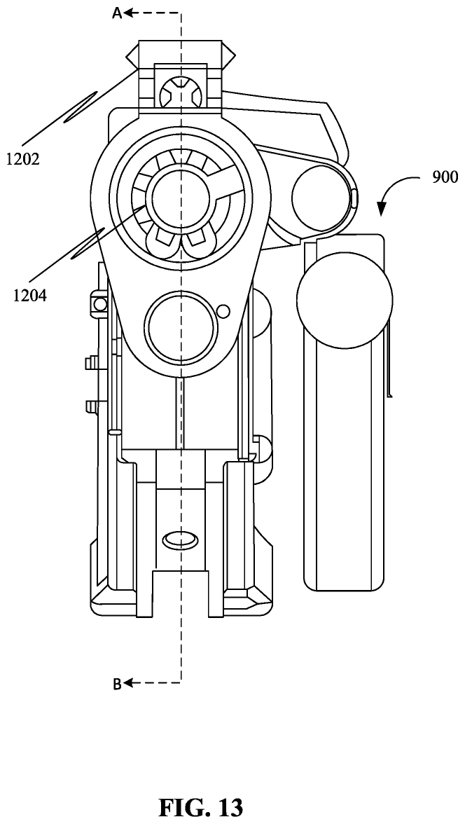

FIG. 13 is a side view of the launching assembly 900 with the projectile launching system 1202, in accordance with some embodiments.

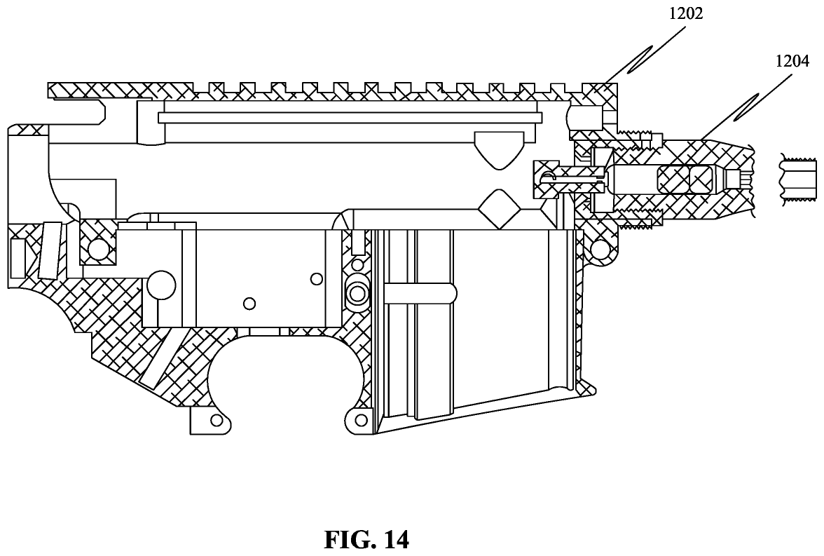

FIG. 14 is a cross-sectional view of the projectile launching system 1202 taken along a line A-B of the FIG. 13, in accordance with some embodiments

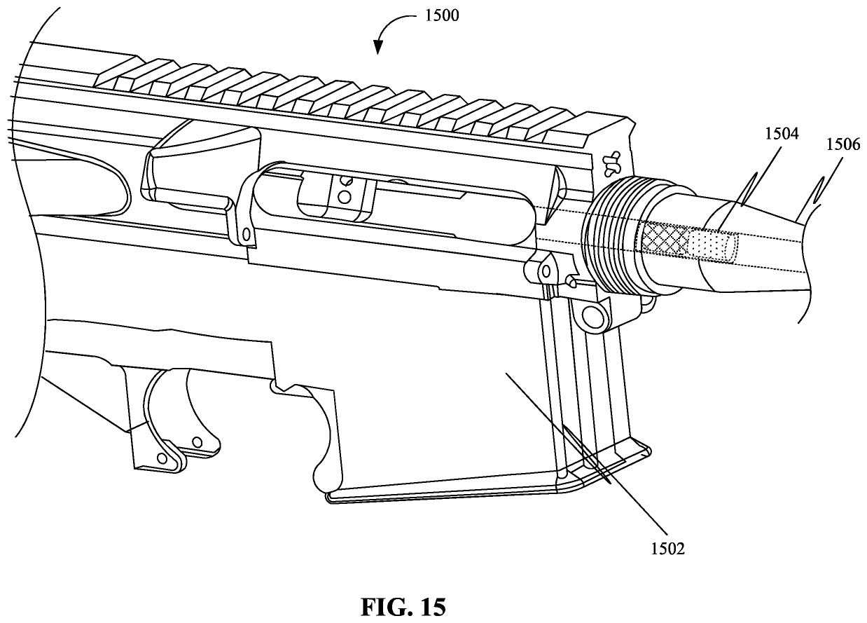

FIG. 15 is a schematic view of a kit 1500 for facilitating cleaning a projectile launching system 1502, in accordance with some embodiments. Further, the kit 1500 may include at least one cleaning ammunition 1504 and the projectile launching system 1502.

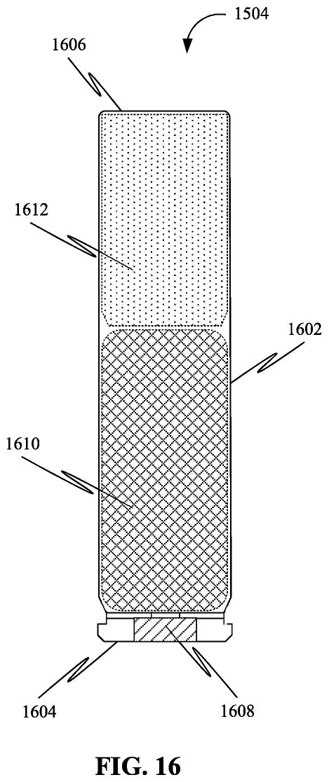

Further, the at least one cleaning ammunition 1504 may include a casing 1602, as shown in FIG. 16, and at least one cleaning projectile 1612. Further, the casing 1602 may be traversable through a barrel 1506 of the projectile launching system 1502. Further, the casing 1602 may include a proximal end 1604, as shown in FIG. 16 and a distal end 1606, as shown in FIG. 16. Further, the casing 1602 may include at least one propellant 1610, as shown in FIG. 16, disposed within an interior space of the casing 1602 at the proximal end 1604. Further, the casing 1602 may include a primer 1608, as shown in FIG. 16, disposed alongside the at least one propellant 1610. Further, the at least one cleaning projectile 1612 may be disposed within the interior space adjacent to the at least one propellant 1610. Further, the at least one cleaning projectile 1612 may be disposed at the distal end 1606 of the casing 1602. Further, the at least one cleaning projectile 1612 may be configured for performing at least one cleaning action on the barrel 1506.

Further, the projectile launching system 1502 configured for launching at least one cleaning ammunition 1504 through the barrel 1506. Further, a launching mechanism of the projectile launching system 1502 may be configured for transferring a striking force to the primer 1608. Further, the primer 1608 may be configured to ignite the at least one propellant 1610 based on the transferring of the striking force.

Further, in some embodiments, the at least one cleaning projectile 1612 may include a first cleaning projectile, a second cleaning projectile, a third cleaning projectile, and a fourth cleaning projectile. Further, the first cleaning projectile may include at least one cleaning agent. Further, the second cleaning projectile may include the at least one cleaning agent and at least one lubricating agent. Further, the third cleaning projectile may include the at least one lubricating agent and at least one cleaning wad. Further, the fourth cleaning projectile may include the at least one cleaning wad. Further, in an embodiment, the cleaning ammunition may include a plurality of cleaning ammunitions. Further, the projectile launching system 1502 may be configurable for launching the plurality of cleaning ammunitions through the barrel 1506 for facilitating the cleaning of the barrel 1506. Further, each cleaning ammunition of the plurality of cleaning ammunitions may be associated with an index of a plurality of indices. Further, the plurality of cleaning ammunitions may include a first cleaning ammunition, a second cleaning ammunition, a third cleaning ammunition, a fourth cleaning ammunition, a fifth cleaning ammunition, a sixth cleaning ammunition, a seventh cleaning ammunition associated, an eighth cleaning ammunition, a ninth cleaning ammunition, and a tenth cleaning ammunition. Further, the plurality of cleaning ammunitions may be launched in an ascending order of the index. Further, the first cleaning ammunition, the second cleaning ammunition, and the third cleaning ammunition may include the first cleaning projectile. Further, the fourth cleaning ammunition, the fifth cleaning ammunition, and the sixth cleaning ammunition may include the second cleaning projectile. Further, the seventh cleaning ammunition and the eighth cleaning ammunition may include the third cleaning projectile. Further, the ninth cleaning ammunition and the tenth cleaning ammunition may include the fourth cleaning projectile.

Further, in some embodiments, the at least one cleaning projectile 1612 may include at least one projectile and at least one of at least one cleaning agent, at least one lubricating agent, and at least one cleaning wad disposed on an outer surface of the at least one projectile. Further, in an embodiment, the at least one projectile may include at least one projectile material. Further, the at least one projectile may be propelled through the barrel 1506 with at least one projectile velocity based on the ignition of the at least one propellant 1610. Further, the at least one projectile may be destructive for at least one object based on the at least one projectile material and the at least one projectile velocity. Further, in an embodiment, the at least one projectile may be traversable through the barrel 1506. Further, the at least one projectile may be propelled through the barrel 1506 based on the ignition of the at least one propellant 1610. Further, the at least one projectile does not perform the at least one cleaning action. Further, the at least one projectile may be configured for carrying the at least one of the at least one cleaning agent, the at least one lubricating agent, and the at least one cleaning wad through the barrel 1506 for performing the at least one cleaning action.

Further, in some embodiments, the barrel 1506 may include at least one material disposed in the barrel 1506. Further, the at least one material may include a carbon material. Further, the carbon material may be deposited on an inner surface of the barrel 1506. Further, the at least one cleaning projectile 1612 may be configured for fragmenting the carbon material. Further, the at least one cleaning projectile 1612 may be configured for expelling the carbon material through an opening of the barrel 1506. Further, the at least one cleaning projectile 1612 may be configured for removing the at least one material from the barrel 1506 based on the expelling.

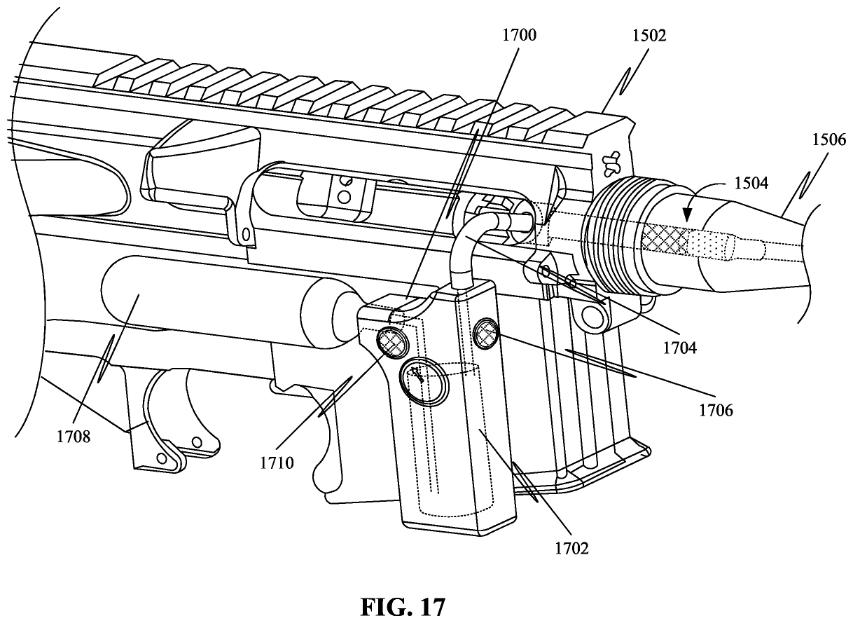

In further embodiments, a launching assembly 1700, as shown in FIG. 17, may be coupled with the projectile launching system 1502. Further, the launching assembly 1700 may be configured for launching the cleaning ammunition through the barrel 1506 of the projectile launching system 1502. Further, the launching assembly 1700 may include at least one chamber 1702, a switch 1706, and at least one tube 1704. Further, a first end of the at least one tube 1704 may be coupled with the at least one chamber 1702. Further, a second end of the at least one tube 1704 may be disposable in the barrel 1506 adjacent to the proximal end 1604 of the casing 1602. Further, the switch 1706 may be coupled with the at least one chamber 1702. Further, the at least one chamber 1702 may include at least one first propellant. Further, the switch 1706 may be configured for receiving a switching action. Further, the switch 1706 may be configured for releasing the at least one first propellant from the at least one chamber 1702 to the barrel 1506 through the at least one tube 1704 based on the receiving of the switching action. Further, the at least one cleaning projectile 1612 may be launched through the barrel 1506 based on the releasing. Further, in an embodiment, the launching assembly 1700 may include at least one first chamber 1708 and at least one first switch 1710. Further, the at least one first chamber 1708 may be coupled with the at least one chamber 1702. Further, the at least one first switch 1710 may be coupled with the at least one first chamber 1708. Further, the at least one first chamber 1708 may include at least one cartridge of the at least one first propellant. Further, the at least one first switch 1710 may be configured for receiving a switching action. Further, the at least one cartridge may be configured for rapturing based on the receiving of the switching action. Further, the at least one cartridge releases the at least one first propellant into the at least one chamber 1702 based on the rapturing.

Further, in some embodiments, the at least one cleaning projectile 1612 may include at least one cleaning material. Further, a gas system of the projectile launching system 1502 may be coupled with the barrel 1506. Further, the at least one cleaning projectile 1612 may be configured for dispensing the at least one cleaning material in the barrel 1506 and the gas system. Further, the at least one cleaning material may be configured for performing the at least one cleaning action on the barrel 1506 and the gas system.

FIG. 16 is a front view of the at least one cleaning ammunition 1504, in accordance with some embodiments.

FIG. 17 is a perspective view of the launching assembly 1700 with the projectile launching system 1502, in accordance with some embodiments.

Although the present disclosure has been explained in relation to its preferred embodiment, it is to be understood that many other possible modifications and variations can be made without departing from the spirit and scope of the disclosure.

1. A cleaning ammunition for facilitating cleaning of a projectile launching system, the cleaning ammunition comprising:
a casing traversable through a barrel of the projectile launching system, wherein the casing comprises a proximal end and a distal end, wherein the casing comprises at least one propellant disposed within an interior space of the casing at the proximal end, wherein the casing further comprises a primer disposed alongside the at least one propellant, wherein the primer is configured to ignite the at least one propellant based on a striking force receivable from a launching mechanism of the projectile launching system; and
at least one cleaning projectile disposed within the interior space adjacent to the at least one propellant, wherein the at least one cleaning projectile is disposed at the distal end of the casing, wherein the at least one cleaning projectile is configured for performing at least one cleaning action on the barrel.

2. The cleaning ammunition of claim 1, wherein the at least one cleaning projectile comprises a first cleaning projectile, a second cleaning projectile, a third cleaning projectile, and a fourth cleaning projectile, wherein the first cleaning projectile comprises at least one cleaning agent, wherein the second cleaning projectile comprises the at least one cleaning agent and at least one lubricating agent, wherein the third cleaning projectile comprises the at least one lubricating agent and at least one cleaning wad, wherein the fourth cleaning projectile comprises the at least one cleaning wad.

3. The cleaning ammunition of claim 2, wherein the cleaning ammunition comprises a plurality of cleaning ammunitions, wherein the projectile launching system is configurable for launching the plurality of cleaning ammunitions through the barrel for facilitating the cleaning of the barrel, wherein each cleaning ammunition of the plurality of cleaning ammunitions is associated with an index of a plurality of indices, wherein the plurality of cleaning ammunitions comprises a first cleaning ammunition, a second cleaning ammunition, a third cleaning ammunition, a fourth cleaning ammunition, a fifth cleaning ammunition, a sixth cleaning ammunition, a seventh cleaning ammunition associated, an eighth cleaning ammunition, a ninth cleaning ammunition, and a tenth cleaning ammunition, wherein the plurality of cleaning ammunitions is launched in an ascending order of the index, wherein the first cleaning ammunition, the second cleaning ammunition, and the third cleaning ammunition comprises the first cleaning projectile, wherein the fourth cleaning ammunition, the fifth cleaning ammunition, and the sixth cleaning ammunition comprises the second cleaning projectile, wherein the seventh cleaning ammunition and the eighth cleaning ammunition comprises the third cleaning projectile, wherein the ninth cleaning ammunition and the tenth cleaning ammunition comprises the fourth cleaning projectile.

4. The cleaning ammunition of claim 1, wherein the at least one cleaning projectile comprises at least one projectile and at least one of at least one cleaning agent, at least one lubricating agent, and at least one cleaning wad disposed on an outer surface of the at least one projectile.

5. The cleaning ammunition of claim 4, wherein the at least one projectile comprises at least one projectile material, wherein the at least one projectile is propelled through the barrel with at least one projectile velocity based on the ignition of the at least one propellant, wherein the at least one projectile is destructive for at least one object based on the at least one projectile material and the at least one projectile velocity.

6. The cleaning ammunition of claim 4, wherein the at least one projectile is traversable through the barrel, wherein the at least one projectile is propelled through the barrel based on the ignition of the at least one propellant, wherein the at least one projectile does not perform the at least one cleaning action, wherein the at least one projectile is configured for carrying the at least one of the at least one cleaning agent, the at least one lubricating agent, and the at least one cleaning wad through the barrel for performing the at least one cleaning action.

7. The cleaning ammunition of claim 1, wherein the barrel comprises at least one material disposed in the barrel, wherein the at least one material comprises a carbon material, wherein the carbon material is deposited on an inner surface of the barrel, wherein the at least one cleaning projectile is configured for fragmenting the carbon material, wherein the at least one cleaning projectile is configured for expelling the carbon material through an opening of the barrel, wherein the at least one cleaning projectile is configured for removing the carbon material from the barrel based on the expelling.

8. The cleaning ammunition of claim 1 further comprising a launching assembly coupled with the projectile launching system, wherein the launching assembly is configured for launching the cleaning ammunition through the barrel of the projectile launching system, wherein the launching assembly comprises at least one chamber, a switch, and at least one tube, wherein a first end of the at least one tube is coupled with the at least one chamber, wherein a second end of the at least one tube is disposable in the barrel adjacent to the proximal end of the casing, wherein the switch is coupled with the at least one chamber, wherein the at least one chamber comprises at least one first propellant, wherein the switch is configured for receiving a switching action, wherein the switch is configured for releasing the at least one first propellant from the at least one chamber to the barrel through the at least one tube based on the receiving of the switching action, wherein the at least one cleaning projectile is launched through the barrel based on the releasing.

9. The cleaning ammunition of claim 8, wherein the launching assembly comprises at least one first chamber and at least one first switch, wherein the at least one first chamber is coupled with the at least one chamber, wherein the at least one first switch is coupled with the at least one first chamber, wherein the at least one first chamber comprises at least one cartridge of the at least one first propellant, wherein the at least one first switch is configured for receiving a switching action, wherein the at least one cartridge is configured for rapturing based on the receiving of the switching action, wherein the at least one cartridge releases the at least one first propellant into the at least one chamber based on the rapturing.

10. The cleaning ammunition of claim 1, wherein the at least one cleaning projectile comprises at least one cleaning material, wherein a gas system of the projectile launching system is coupled with the barrel, wherein the at least one cleaning projectile is configured for dispensing the at least one cleaning material in the barrel and the gas system, wherein the at least one cleaning material is configured for performing the at least one cleaning action on the barrel and the gas system.

11. A kit for facilitating cleaning a projectile launching system, wherein the kit comprising:
at least one cleaning ammunition comprising:
a casing traversable through a barrel of the projectile launching system, wherein the casing comprises a proximal end and a distal end, wherein the casing comprises at least one propellant disposed within an interior space of the casing at the proximal end, wherein the casing further comprises a primer disposed alongside the at least one propellant; and
at least one cleaning projectile disposed within the interior space adjacent to the at least one propellant, wherein the at least one cleaning projectile is disposed at the distal end of the casing, wherein the at least one cleaning projectile is configured for performing at least one cleaning action on the barrel; and
the projectile launching system configured for launching at least one cleaning ammunition through the barrel, wherein a launching mechanism of the projectile launching system is configured for transferring a striking force to the primer, wherein the primer is configured to ignite the at least one propellant based on the transferring of the striking force.

12. The kit of claim 11, wherein the at least one cleaning projectile comprises a first cleaning projectile, a second cleaning projectile, a third cleaning projectile, and a fourth cleaning projectile, wherein the first cleaning projectile comprises at least one cleaning agent, wherein the second cleaning projectile comprises the at least one cleaning agent and at least one lubricating agent, wherein the third cleaning projectile comprises the at least one lubricating agent and at least one cleaning wad, wherein the fourth cleaning projectile comprises the at least one cleaning wad.

13. The kit claim 12, wherein the cleaning ammunition comprises a plurality of cleaning ammunitions, wherein the projectile launching system is configurable for launching the plurality of cleaning ammunitions through the barrel for facilitating the cleaning of the barrel, wherein each cleaning ammunition of the plurality of cleaning ammunitions is associated with an index of a plurality of indices, wherein the plurality of cleaning ammunitions comprises a first cleaning ammunition, a second cleaning ammunition, a third cleaning ammunition, a fourth cleaning ammunition, a fifth cleaning ammunition, a sixth cleaning ammunition, a seventh cleaning ammunition associated, an eighth cleaning ammunition, a ninth cleaning ammunition, and a tenth cleaning ammunition, wherein the plurality of cleaning ammunitions is launched in an ascending order of the index, wherein the first cleaning ammunition, the second cleaning ammunition, and the third cleaning ammunition comprises the first cleaning projectile, wherein the fourth cleaning ammunition, the fifth cleaning ammunition, and the sixth cleaning ammunition comprises the second cleaning projectile, wherein the seventh cleaning ammunition and the eighth cleaning ammunition comprises the third cleaning projectile, wherein the ninth cleaning ammunition and the tenth cleaning ammunition comprises the fourth cleaning projectile.

14. The kit of claim 11, wherein the at least one cleaning projectile comprises at least one projectile and at least one of at least one cleaning agent, at least one lubricating agent, and at least one cleaning wad disposed on an outer surface of the at least one projectile.

15. The kit of claim 14, wherein the at least one projectile comprises at least one projectile material, wherein the at least one projectile is propelled through the barrel with at least one projectile velocity based on the ignition of the at least one propellant, wherein the at least one projectile is destructive for at least one object based on the at least one projectile material and the at least one projectile velocity.

16. The kit of claim 14, wherein the at least one projectile is traversable through the barrel, wherein the at least one projectile is propelled through the barrel based on the ignition of the at least one propellant, wherein the at least one projectile does not perform the at least one cleaning action, wherein the at least one projectile is configured for carrying the at least one of the at least one cleaning agent, the at least one lubricating agent, and the at least one cleaning wad through the barrel for performing the at least one cleaning action.

17. The kit of claim 11, wherein the barrel comprises at least one material disposed in the barrel, wherein the at least one material comprises a carbon material, wherein the carbon material is deposited on an inner surface of the barrel, wherein the at least one cleaning projectile is configured for fragmenting the carbon material, wherein the at least one cleaning projectile is configured for expelling the carbon material through an opening of the barrel, wherein the at least one cleaning projectile is configured for removing the carbon material from the barrel based on the expelling.

18. The kit of claim 11 further comprising a launching assembly coupled with the projectile launching system, wherein the launching assembly is configured for launching the cleaning ammunition through the barrel of the projectile launching system, wherein the launching assembly comprises at least one chamber, a switch, and at least one tube, wherein a first end of the at least one tube is coupled with the at least one chamber, wherein a second end of the at least one tube is disposable in the barrel adjacent to the proximal end of the casing, wherein the switch is coupled with the at least one chamber, wherein the at least one chamber comprises at least one first propellant, wherein the switch is configured for receiving a switching action, wherein the switch is configured for releasing the at least one first propellant from the at least one chamber to the barrel through the at least one tube based on the receiving of the switching action, wherein the at least one cleaning projectile is launched through the barrel based on the releasing.

19. The kit of claim 18, wherein the launching assembly comprises at least one first chamber and at least one first switch, wherein the at least one first chamber is coupled with the at least one chamber, wherein the at least one first switch is coupled with the at least one first chamber, wherein the at least one first chamber comprises at least one cartridge of the at least one first propellant, wherein the at least one first switch is configured for receiving a switching action, wherein the at least one cartridge is configured for rapturing based on the receiving of the switching action, wherein the at least one cartridge releases the at least one first propellant into the at least one chamber based on the rapturing.

20. The kit of claim 11, wherein the at least one cleaning projectile comprises at least one cleaning material, wherein a gas system of the projectile launching system is coupled with the barrel, wherein the at least one cleaning projectile is configured for dispensing the at least one cleaning material in the barrel and the gas system, wherein the at least one cleaning material is configured for performing the at least one cleaning action on the barrel and the gas system.
